(19) United States
(12) Patent Application Publication
(10) Pub. No.: US 2025/0208162 A1
(43) Pub. Date: Jun. 26, 2025

(54) Quantum inertial measurement unit and method for acquiring at least one physical measured quantity

(71) Applicant: GOTTFRIED WILHELM LEIBNIZ UNIVERSITÄT HANNOVER KÖRPERSCHAFT DES ÖFFENTLICHEN RECHTS, Hannover (DE)

(72) Inventors: Knut Enno STOLZENBERG, Hannover (DE); Sebastian BODE, Burgdorf (DE); Ernst Maria RASEL, Hannover (DE); Naceur GAALOUL, Hannover (DE); Dennis SCHLIPPERT, Hannover (DE)

(21) Appl. No.: 18/985,568

(22) Filed: Dec. 18, 2024

(30) Foreign Application Priority Data
Dec. 22, 2023 (EP) 23219715.2

(51) Int. Cl. G01P 15/09

(52) U.S. Cl. CPC G01P 15/09

(57) ABSTRACT

The invention relates to a quantum inertial measurement unit for acquiring at least one physical measured quantity based on atom-interferometric acceleration measurement. The invention further relates to a method for acquiring at least one physical measured quantity based on atom-interferometric acceleration measurement by means of a quantum inertial measurement unit of this type.

The invention relates to a quantum inertial measurement unit for acquiring at least one physical measured quantity based on atom-interferometric acceleration measurement. The invention further relates to a method for acquiring at least one physical measured quantity based on atom-interferometric acceleration measurement by means of a quantum inertial measurement unit of this type.

One-dimensional atom-interferometric acceleration measurements with cold atoms are already extensively known in the prior art. Proposals also already exist for extending such atom-interferometric measurements to a plurality of spatial directions and additional measured quantities, in particular angular velocity, angular acceleration, etc. However, these proposals [1, 2, 3, 4, 5, 6, 7] require substantially increased equipment outlay compared with one-dimensional acceleration measurement. In some instances, complex approaches to the simultaneous measurement of a plurality of quantities and axes [6, 7] are proposed.

The object of the invention is to enable the acquisition of at least one physical measured quantity based on atom-interferometric acceleration measurement with reduced outlay.

This object is achieved by a quantum inertial measurement unit for acquiring at least one physical measured quantity based on atom-interferometric acceleration measurement, having:
a) at least one atom trap which is configured to capture an atomic cloud,
b) at least one controllable splitting device which is configured to create a plurality of macroscopic atomic sub-clouds in a defined geometric arrangement, spatially separated from one another, in the atomic cloud captured in the atom trap, by means of cold or ultracold quantum gases such as, for example, Bose-Einstein condensates, depending on at least one control signal,
c) at least one atomic optical light field device which is configured in each case to carry out an atom-interferometric one-dimensional acceleration measurement by means of the created macroscopic atomic sub-clouds, wherein an acceleration value is determined for each macroscopic atomic sub-cloud,
d) at least one evaluation device which is configured to determine a physical measured quantity other than the measured one-dimensional acceleration values from the plurality of one-dimensional acceleration values obtained by means of the at least one atomic optical light field device.

The invention offers the advantage that a plurality of individual atom interferometers can be formed in the same atom trap with components of the device which are required in any case for a one-dimensional acceleration measurement, with only slightly increased equipment outlay, i.e. by means of the macroscopic atomic sub-clouds which are spatially separated from one another and can be used individually in each case for an atom-interferometric one-dimensional acceleration measurement. In this way, a plurality of one-dimensional acceleration values, from which the desired other physical measured quantity can then be determined, can be obtained with little equipment outlay. The macroscopic atomic sub-clouds can be e.g. macroscopic quantum objects or other macroscopically separated atomic clouds, such as e.g. thermal atomic clouds at a few microkelvins or more, in which no quantum characteristic is directly expressed.

The atomic optical light field device can resemble, for example, a laser interferometer, wherein the atomic optical light field device can have e.g. a single or multiple photon light field containing the atomic optics, e.g. in the form of a beam splitting with momentum transfer.

According to one advantageous embodiment of the invention, it is provided that the controllable splitting device is configured to create the macroscopic atomic sub-clouds in a defined geometric arrangement in the form of a regular or irregular two-dimensional or three-dimensional matrix arrangement. Due to a defined geometric arrangement of this type, the determining equations for determining the other physical measured quantity from the plurality of one-dimensional acceleration values of the plurality of atom interferometers or macroscopic atomic sub-clouds can be kept simple so that the required computing outlay can be minimized and, in particular, a characterization/calibration can be performed more simply through controlled tuning of the distances.

According to one advantageous embodiment of the invention, it is provided that the matrix arrangement has at least two, at least four, at least six or at least nine matrix elements in the form of the macroscopic atomic sub-clouds. A multiplicity of individual one-dimensional acceleration values can be determined in this way with essentially the same device design, which in turn enables the determination of a plurality of different other physical measured quantities from these acceleration values. The matrix arrangement can be designed, for example, at least as a 1×2 matrix or a 2×1 matrix. As shown below, a 3×3 matrix design, for example, is advantageous.

According to one advantageous embodiment of the invention, it is provided that the defined geometric arrangement of the macroscopic atomic sub-clouds in one plane comprises an area of at least 0.5 mm² or at least 1 mm². A sufficient physical separation of the individual macroscopic atomic sub-clouds and correspondingly the performance of separate interferometric measurements on the atomic sub-clouds can be ensured in this way. The macroscopic atomic sub-clouds can be arranged in one plane. The macroscopic atomic sub-clouds can be arranged as distributed over a three-dimensional spatial area, e.g. in the form of a three-dimensional matrix arrangement. The macroscopic atomic sub-clouds can also be arranged as distributed in a one-dimensional arrangement.

Generally speaking, the distance between the central points of adjacent macroscopic atomic sub-clouds can be at least 0.3 mm, at least 0.7 mm or at least 1 mm. In the case of a three-dimensional matrix arrangement, the defined geometric arrangement of the macroscopic atomic sub-clouds can comprise a volume of at least 0.125 mm³ or at least 1 mm³.

According to one advantageous embodiment of the invention, it is provided that the evaluation device is configured to determine, as the physical measured quantity, one or more rotational rates, one or more rotational accelerations, one or more acceleration gradients, one or more magnetic field components and/or at least one other inertial measured quantity. The quantum inertial measurement unit according to the invention can accordingly be used universally and allows highly accurate determinations of further physical measured quantities from the one-dimensional acceleration measurements.

The invention is suitable for both freely moving atomic clouds and for optically guided atomic clouds, e.g. for interferometry in a waveguide. The at least one atom trap can be configured, for example, to capture the atomic cloud in a vacuum system, e.g. a vacuum chamber or a glass cell.

According to one advantageous embodiment of the invention, it is provided that the quantum inertial measurement unit has at least one waveguide, wherein the atom trap is configured to capture the atomic cloud in the waveguide. In this way, the design of the device can be further simplified and the measurement accuracy can be increased. The macroscopic atomic sub-clouds can then be created in the waveguide.

According to one advantageous embodiment of the invention, it is provided that the atomic optical light field device is configured to carry out interferometric measurements on the macroscopic atomic sub-clouds by means of coherent single or multiple photon processes. This allows the functionalization of a plurality of macroscopic atomic sub-clouds in the quantum inertial measurement unit as separate interferometers with little outlay and high measurement accuracy. The atomic optical light field device can be configured, for example, to carry out interferometric measurements on the macroscopic atomic sub-clouds by means of at least one diffraction process such as e.g. Bragg, double Bragg, Raman, double Raman, single-photon diffraction.

According to one advantageous embodiment of the invention, it is provided that the atom trap is designed as a magneto-optical atom trap. This allows reliable provision of the atomic cloud with little equipment outlay.

According to one advantageous embodiment of the invention, it is provided that the quantum inertial measurement unit has a cooling device to cool the atomic cloud, having an evaporative cooling arrangement. In this way, the atoms of the atomic cloud cooled by the laser irradiation can be further cooled into the range of cold or ultracold quantum gases. The evaporative cooling arrangement is configured to carry out an evaporative cooling of the atomic cloud. In the evaporative cooling, the highest-energy atoms are removed from the atomic cloud, e.g. through radiofrequency transitions between the different Zeeman states in a magnetic trap.

According to one advantageous embodiment of the invention, it is provided that the controllable splitting device has at least one optical dipole trap and/or at least one magnetic trap. The controllable splitting device has the function of subdividing the atomic cloud into the macroscopic atomic sub-clouds separated from one another. This is achieved in a particularly efficient manner with little equipment outlay by means of an optical dipole trap and/or at least one magnetic trap.

According to one advantageous embodiment of the invention, it is provided that the at least one optical dipole trap has at least two beam paths, in particular at least two intersecting beam paths or at least two parallel beam paths. In this way, respective atom-interferometric measurements can be carried out in the area of the intersecting beams on a macroscopic atomic sub-cloud located in the area of the intersection point of the beams. In the case of parallel beams, the measurements can be carried out one-dimensionally on two macroscopic atomic sub-clouds in the beam path.

According to one advantageous embodiment of the invention, it is provided that the controllable splitting device has at least one controllable optical splitting unit, in particular a deflector, by means of which at least one beam path of the optical dipole trap is splittable into a plurality of beam sub-paths. As a result, a plurality of atom-interferometric measurements separated from one another can then be carried out on the macroscopic atomic sub-clouds separated from one another with only a slight increase in the equipment outlay compared with an atom interferometer configured for one-dimensional acceleration measurement. The controllable optical deflector can be e.g. an acousto-optic deflector which is configured to generate different light beam deflections depending on fed-in alternating signals having a varying frequency.

The aforementioned object is further achieved by a method for acquiring at least one physical measured quantity based on atom-interferometric acceleration measurement by means of a quantum inertial measurement unit, in particular a quantum inertial measurement unit of the type explained above, having the following features:
a) an atomic cloud is captured by means of an atom trap,
b) depending on at least one control signal, a plurality of macroscopic atomic sub-clouds are created in a defined geometric arrangement in the atomic cloud captured in the atom trap, by means of a controllable splitting device and by means of cold or ultracold quantum gases, such as, for example, Bose-Einstein condensates,
c) an atom-interferometric one-dimensional acceleration measurement is carried out in each case by means of an atomic optical light field device and by means of the created macroscopic atomic sub-clouds, wherein an acceleration value is determined for each macroscopic atomic sub-cloud,
d) a physical measured quantity other than the measured one-dimensional acceleration values is determined by means of at least one evaluation device from the plurality of one-dimensional acceleration values obtained by means of the at least one atomic optical light field device.

The advantages explained above can also be achieved in this way.

The invention described here is suitable for the field of inertial sensor systems and navigation. In particular, a method is described with which a conventional atom-interferometric 1D acceleration measurement with cold atoms can be extended using dynamic optical potentials to a plurality of spatial directions and additional measured quantities, in particular angular velocity, angular acceleration, spatial gradients, curvature and higher orders.

The invention solves the aforementioned problem and thus provides a simple way—without significantly affecting the complexity and size of the system—of substantially extending the function of existing systems with little outlay. An extension of this type is of great importance particularly in cases where the SWAP (Size, Weight, and Power) budget is expensive and important, i.e. on transportable platforms, for example on satellite missions for earth observation or in inertial navigation by means of hybrid sensor systems. In this respect, important applications of the invention can be found in the field of inertial navigation and inertial sensor systems in which a design of this type is used on mobile platforms to evaluate local gravitation, accelerations and their spatial derivatives and rotations. In the invention, the large number of individual, correlatable measurements offers a disruptive advantage over the prior art through the facility for differential noise suppression (e.g. vibration noise) and facilities for system characterization (e.g. wavefront analysis of the beam splitter light field by means of moving, scalable atom arrangements and modelling). The additional inertial measured quantities can thus play a central role beyond the usage scenario itself in the characterization and control of systematic effects.

The sensitivity to rotations is based on the combination of two acceleration measurements or velocity measurements separated by a baseline, as is customary e.g. for inertially stabilized platforms [9], or as proposed in ref. [10] for the combination of atom interferometers. The invention benefits from the continuous scalability (distances dₓ and d_{y} can be freely varied from 0 mm to several millimeters) which can serve to adjust the measurement sensitivity to ambient noise or target observables, and also to characterize or calibrate the measurement. Further sensitive axes are quite conceivable through the use of 3D arrangements of the interferometers.

The invention is explained in detail below on the basis of exemplary embodiments with the use of drawings.

In the drawings:

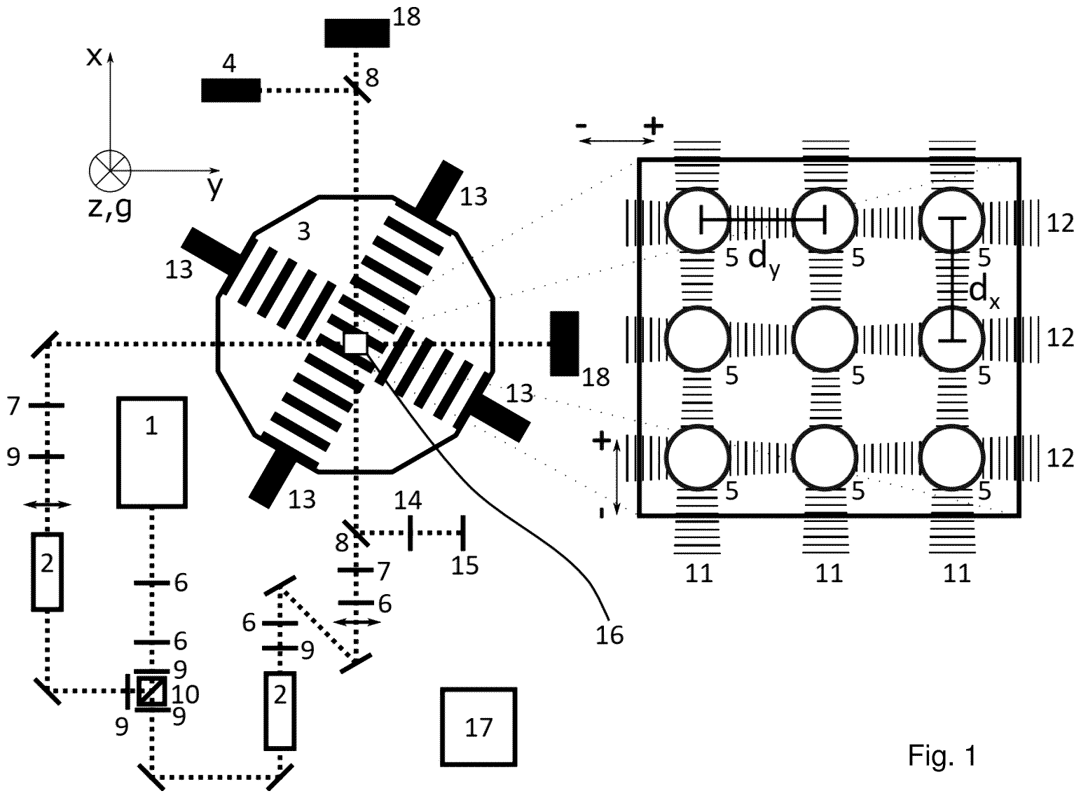

FIG. 1 shows a schematic view of a quantum inertial measurement unit,

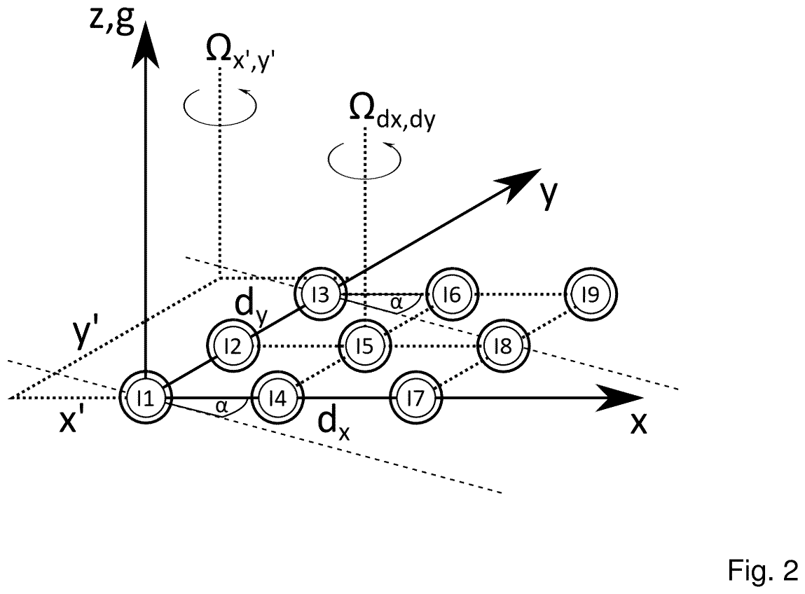

FIG. 2 shows the arrangement of a plurality of macroscopic atomic sub-clouds creatable in the quantum inertial measurement unit,

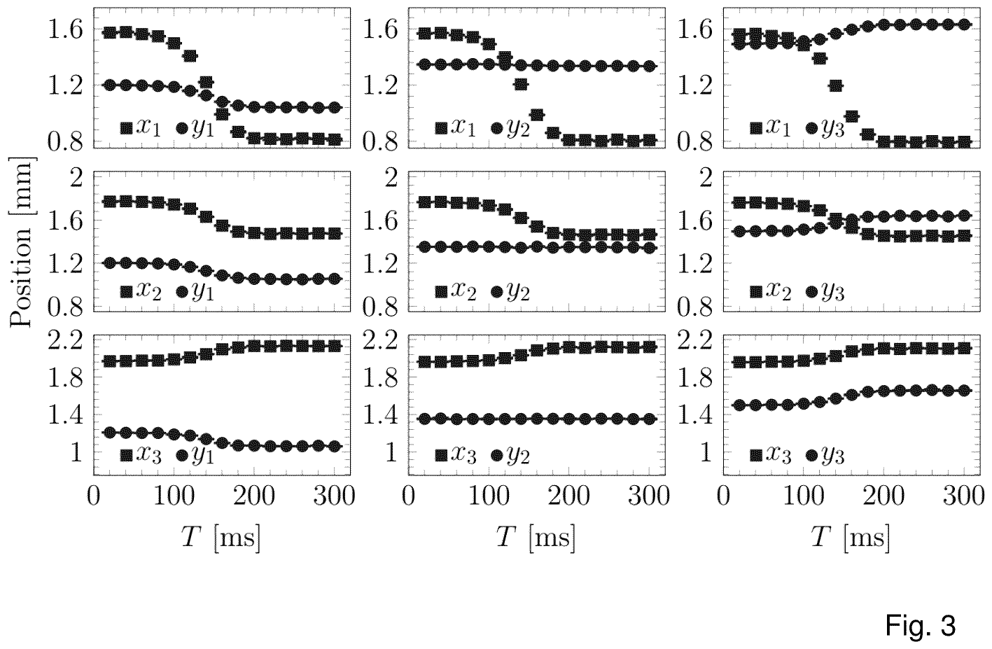

FIG. 3 shows transport trajectories of the macroscopic atomic sub-clouds,

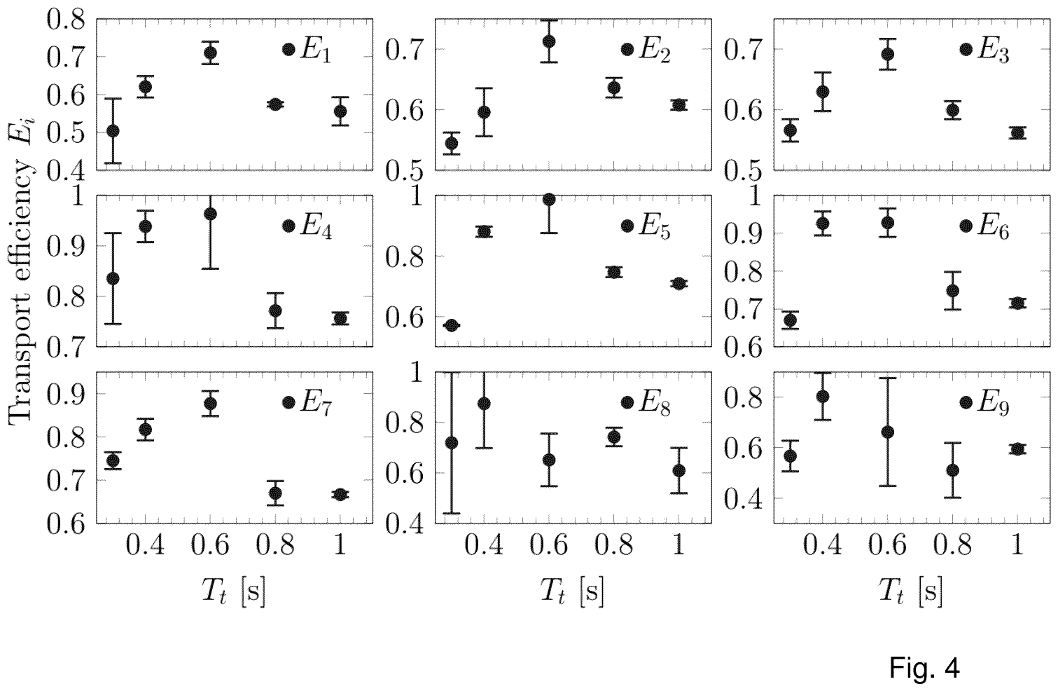

FIG. 4 shows the transport efficiency of the atomic sub-clouds for different ramp durations,

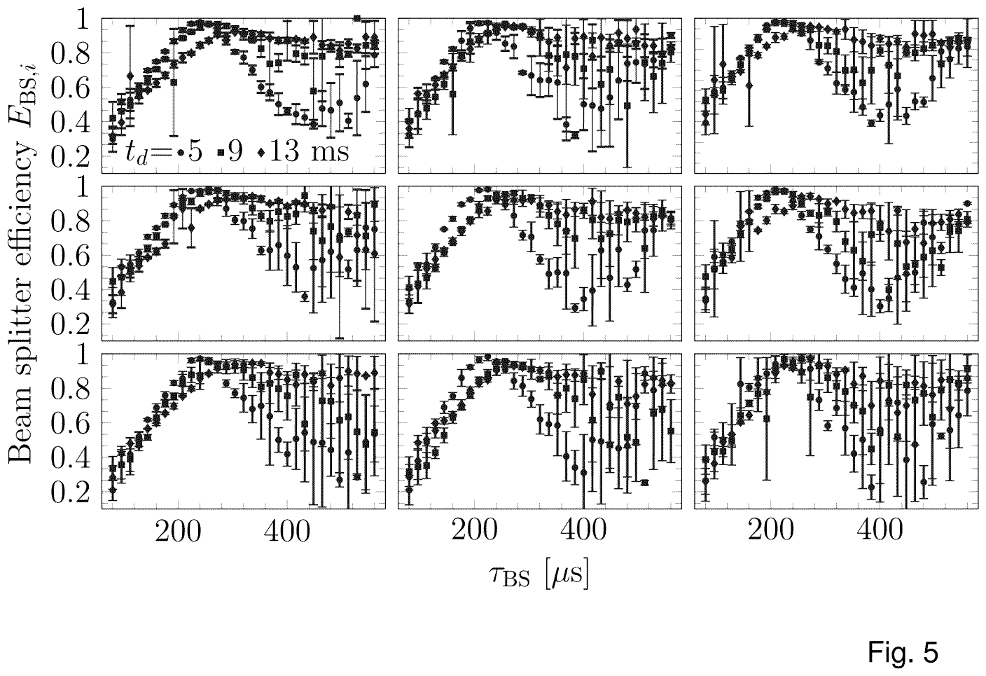

FIG. 5 shows beam splitter efficiency depending on the pulse duration and freefall time,

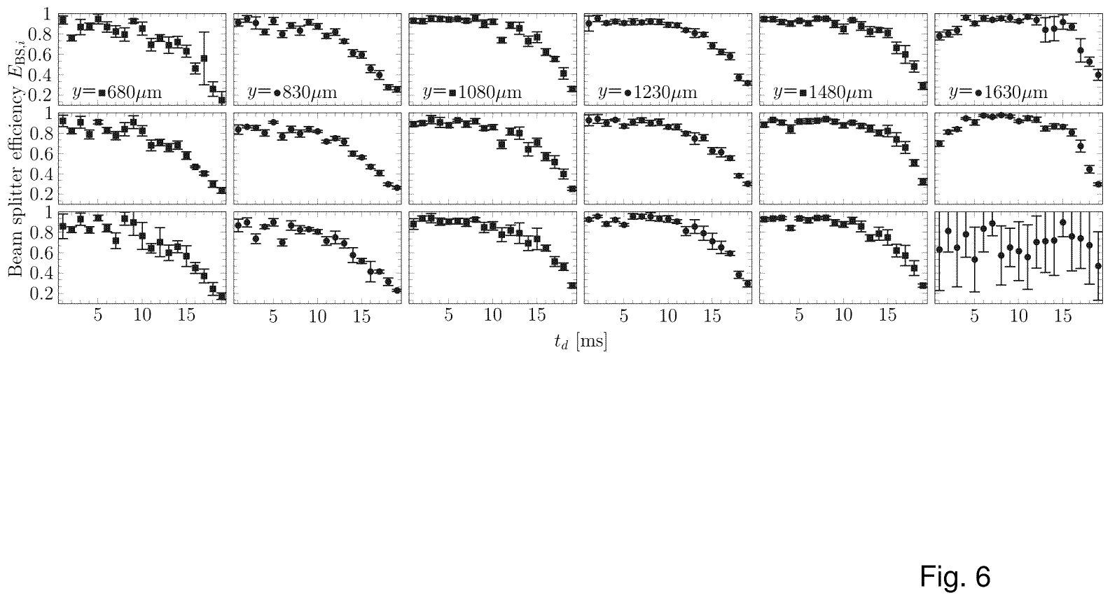

FIG. 6 shows the beam splitter efficiency depending on the Y-position and event time,

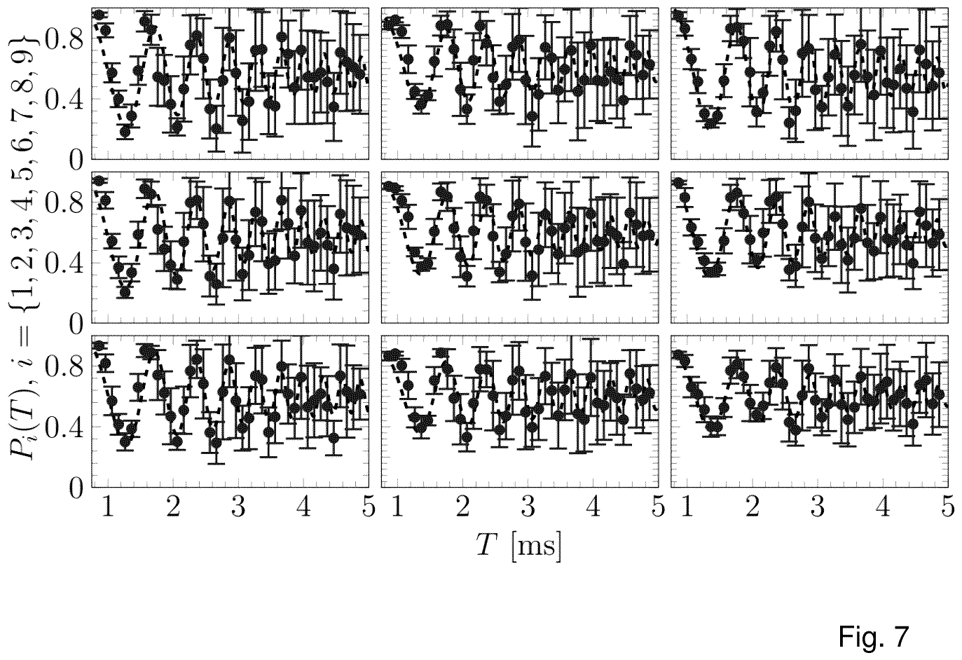

FIG. 7 shows output signals of the nine simultaneous atom interferometers,

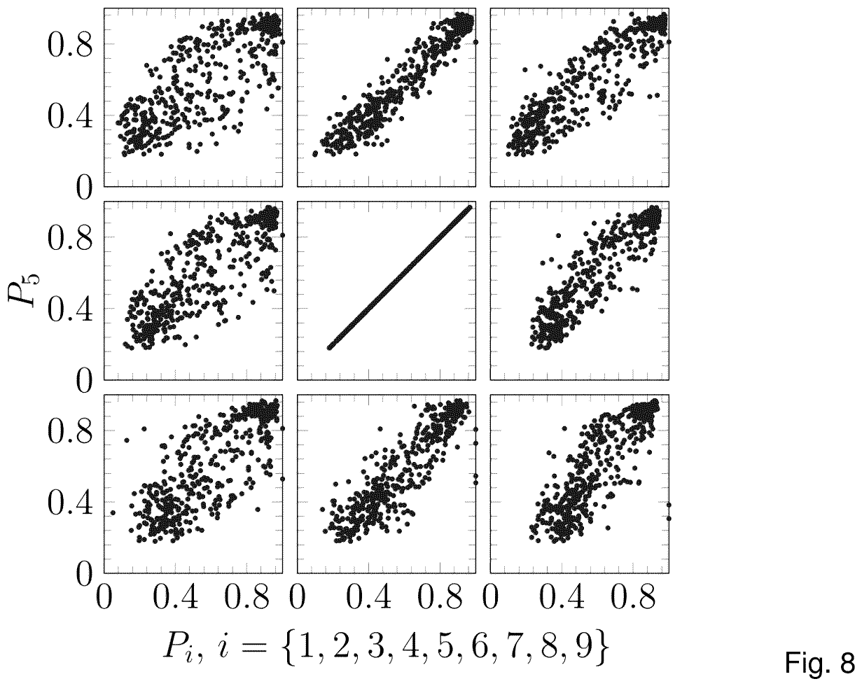

FIG. 8 shows a parametric view of output signals of the nine simultaneous atom interferometers,

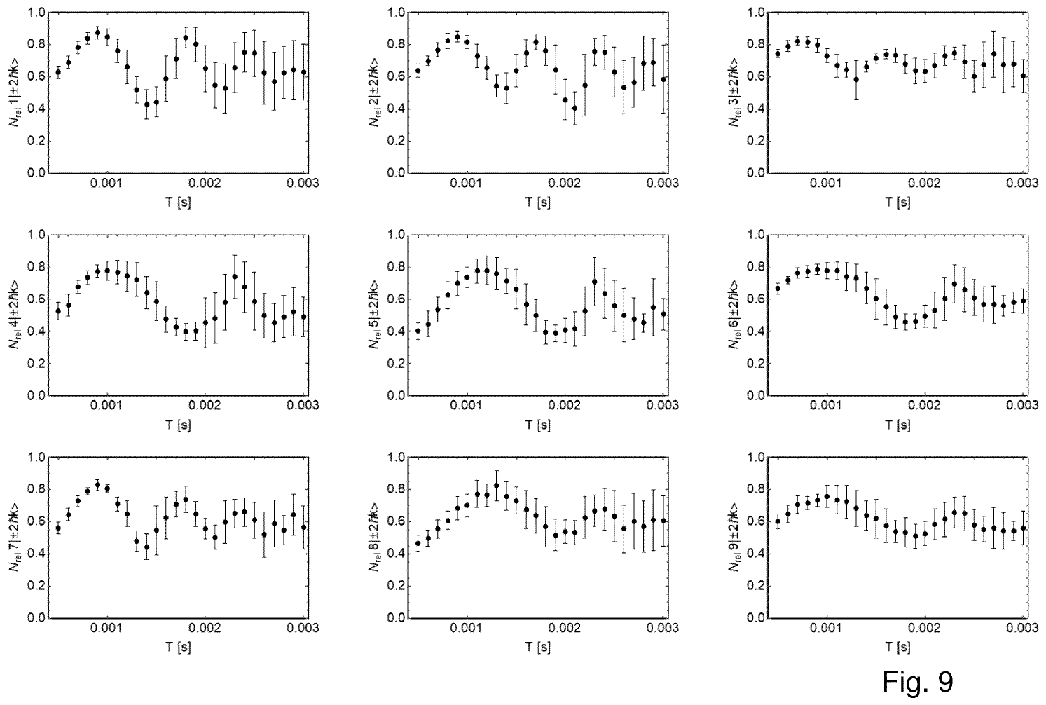

FIG. 9 shows output signals of the nine simultaneous atom interferometers in the 1D waveguide.

FIG. 1 shows a highly schematic view of a quantum inertial measurement unit for measuring a physical measured quantity based on atom-interferometric acceleration measurement. The quantum inertial measurement unit has an atom trap 1, 3, 13, 16. The atom trap further includes optical dipole traps 11, 12, lens systems 6, 7, and also retarders 9 and beam splitters 10. 2D acousto-optic deflectors (AOD) 2, for example, can be used as the controllable splitting device. BEC collimators 4 and dichroic mirrors 8 are also provided to separate the atomic optical light field and the dipole trap beams. An evaluation device 17, e.g. a computer, is provided to evaluate the data.

The quantum inertial measurement units can have, for example, the following individual components:
1 A first laser, e.g. a laser for generating optical potentials averaged over time (e.g. 55 W 1064 nm laser), said laser being used to capture the atomic cloud precooled in the magnetic trap. Subsequent evaporative cooling of the atomic ensemble results in the generation of the quantum degenerate gases.
2 2D-acousto-optic deflectors (AOD): The light from the first laser is diffracted with the acousto-optic deflectors, and the first diffraction order is split into a plurality of sub-beams by means of a suitable applied RF signal. These sub-beams are freely adjustable in their position (in the region of a few millimeters) and amplitude. A 2D-array can be created from potential minima in the experimental chamber by using two 2D-AODs.
3 An experimental chamber with an ultra-high vacuum (UHV).
4 A Bragg collimator: the two sub-beams used for the atom interferometry are guided by means of a fiber to the Bragg collimator. The Bragg collimator transmits the interferometric beams, collimated with diameter of e.g. 6.5 mm, through the experimental chamber 3 where they are retroreflected on reflectors 15, and the polarizations of the sub-beams are rotated through 90° by the λ/4 retarder 14. As a result, the atomic ensembles are made usable for interferometric measurements.
5 Macroscopic atomic sub-clouds, e.g. Bose-Einstein condensates (BEC), in the array. Due to the potential minima arranged in the form of an array. a single BEC can be generated in each one. The BECs are separated from one another by the distances dₓ and d_{y}. The distances can be freely chosen and modified.
6 Beam telescopes to widen the beam of the first laser 1.
7 Focusing lenses: these lenses focus the dipole trap beam in the center of the experimental chamber 3.
8 A dichroic mirror which is transparent for the dipole trap beam (1064 nm) and reflective for the interferometry beams (780 nm).
9 λ/2 retarders to set the polarization of the dipole trap beam. The diffraction efficiency of the AODs is heavily dependent on the polarization of the light. Both dipole trap beams must be orthogonally polarized in the center of the experimental chamber 3 in order to avoid interference effects.
10 A polarization-dependent beam splitter (PBS) to split the dipole trap beam into two beams which implement a crossed dipole trap in the center of the experimental chamber.
11 ODT modes BP1: optical modes of the dipole trap beam in the x-direction. The modes are generated by the 2D-AOD (2).
12 ODT modes BP2: optical modes of the dipole trap beam in the y-direction. The modes are generated by the 2D-AOD (2).
13 MOT collimators which provide laser light for the first cooling stages before the optical dipole trap is loaded. A collimator pair is further provided in the z-direction above and below the center of the experimental chamber, and also a Helmholtz coil pair above and below the experimental chamber (not shown in the drawing) to provide the required magnetic fields.
14 A polarization filter (λ/4 retarder)
15 A reflector
18 The dipole trap beams are blocked with beam traps downstream of the experimental chamber on safety grounds.

A plurality of macroscopic atomic sub-clouds 5 are then created in an area 16 in a matrix arrangement, shown here in a 3×3 matrix, i.e. nine macroscopic atomic sub-clouds 5, with which the nine interferometers I1, I2, I3, I4, I5, I6, I7, I8, I9 independent from one another shown in FIG. 2 can be formed. To do this, the light from the first laser 1 is split in the polarization-dependent beam splitter 10 into two beam paths which are guided crosswise through the experimental chamber 3. The respective beam is split in each beam path by means of the controllable splitting device in each case into e.g. three sub-beams located adjacent to one another.

As an exemplary embodiment, a 2D arrangement of Bose-Einstein condensates (BEC) 5 is described, which is located in an intersecting plane of the two optical dipole trap beams 11, 12. Due to the large spatial deflection (˜ several millimeters) of the foci of the two dipole beams 11, 12, a plurality of potential wells can be generated simultaneously in two dimensions and can be loaded with ⁸⁷Rb atoms previously captured in a magnetic trap and cooled. A BEC 5 can be created in each case in these potential wells through evaporative cooling. The number of ultracold atoms in the arrangement is around ˜3×10⁵. The following are described below:

### Optical Transport of the Arrangement

The distances between the BECs d_{x/y} can be scaled in order to adjust the differential phase sensitivity of the subsequent interferometric measurements. The maximum area enclosed by the arrangement is macroscopic and can be quantified after the transport as 1.5 mm².

### Light Pulse Atom Interferometry

The beam splitter pulses and mirror pulses of the interferometry sequence are demonstrated. Results of interferometric measurements are then presented.

### Phase Sensitivity and Discussion

The differential phase sensitivity of the arrangement is indicated and further proof-of-principle experiments are proposed.

### Optical Transport of the Arrangement

The distance between the BECs 5 can be increased from an initial 300 μm (dₓ) or 150 μm (d_{y}) to a maximum of 750 μm (dₓ) or 500 μm (d_{y}) by means of suitable frequency ramps of the radiofrequency signals applied to the acousto-optic deflectors (AOD) (cf. FIG. 3). The transport trajectories can be sigmoid frequency ramps, wherein the transport efficiency is maximal for ramp durations of 600 ms. Peak transport efficiencies of ˜ 95% could be measured. Characteristic, exponential lifetime losses can be observed for longer ramp durations.

FIG. 3 shows transport trajectories of the individual BECs of the arrangement. The measured trajectories of the BECs of the arrangement are shown here. The individual images in each case describe the x and y position of a single BEC depending on the transport time in ms. The numbering is performed row-by-row from left to right from 1-9. The trajectories resulting in a distance between the BECs of d_{x/y}=600/300 μm are presented by way of example.

FIG. 4 shows transport efficiencies for different ramp durations of 300, 400, 600, 800, 1000 ms. The efficiency was determined by measuring the atomic numbers before the ramp and after the ramp and the mean values are plotted for the relationship T_{eff}=N_{after}/N_{before}.

### Light Pulse Atom Interferometry

The known technology of double-Bragg diffraction is used for implementing the interferometric measurements on the BEC arrangement. The BECs of the arrangement are transferred to the pulse states|±2hk) (beam splitter) and are inverted after an evolution time T (mirror). A further beam splitter pulse which closes the interferometer is injected after a second evolution time T. The relationship of the measured populations of the pulse states|2hk) and |0) allows inferences to be made regarding the phase ¢. The beam splitter pulses or mirror pulses are implemented by means of two orthogonally polarized, retroreflected light fields. The laser system used for this purpose is shown in FIG. 1. The laser beams have a Gaussian-shaped profile and a diameter of around 0.65 cm downstream of the fiber output and telescope. The power in the beams is around 12 mW. Before the Doppel-Bragg pulses are injected, the dipole trap is switched off and the atomic ensembles are in freefall. Since the interferometry beams are aligned more or less horizontally, the time between the dipole trap switch-off and the last beam splitter pulse must be limited to a maximum of 20 ms in order to guarantee a sufficient spatial overlap between the Bragg beams and the fall trajectory of the atoms. Rabi oscillators for three event times t₁=5 ms, t₂=9 ms and t₃=15 ms before the application of the Bragg laser pulses are shown in FIG. 3. The intensity profile of the Bragg pulses is more or less Gaussian-shaped, resulting in a slowing of the Rabi oscillators for longer event times, since the atoms fall from the center of the interferometry beams and the Rabi frequency decreases by the root of the intensity. The maximum efficiency of the beam splitters can be quantified as ˜95% for t₁ and ˜85% for t₃. The intensity profile of the arrangement can be measured by shifting the arrangement orthogonally to the interferometry beams (only y-axis). Measurements for two different y-positions of the arrangement were carried out for this purpose. In the first measurement, the positions of the columns, referenced to the camera chip of the absorption mapping, can be quantified as 830, 1230, 1630 microm and in the second as 680, 1080, 1480 microm. The mirror pulse has a maximum efficiency of ˜85% for roughly the same pulse duration as in FIG. 4 and an event time of 5 ms. This is achieved by doubling the radiofrequency power on the switching AOM (last AOM in the laser system).

FIG. 5 shows the beam splitter efficiency depending on the pulse duration and freefall time (legend). This shows Rabi oscillators which are scanned by sequentially increasing the pulse duration T from 112-472 μs. The times t1=5 ms, t2=9 ms, t3=15 ms represent the duration of the free fall of the atoms before the application of the Bragg laser pulses.

FIG. 6 shows the beam splitter efficiency depending on the y-position and event time. The beam splitter efficiencies are shown for a pulse duration T of 276 μs and varying event times. The y-positions of the columns of the arrangement are indicated in the upper row. The efficiency increases from smaller to greater y-positions, which means that the center of the interferometry beams is shifted in the y-direction.

The output phase of the interferometer is first scaled with the scale factor ϕ=K_{eff}a_{eff}T² with the effective wave vector of the double-Bragg diffraction Kerf and the effective acceleration a_{eff}, which is induced by the tilting of the interferometry beams (angle α in FIG. 3). The acceleration is defined by a_{eff}=g·sin (α), where g=9.81 m/s² is the acceleration due to gravity. The output signals of all nine simultaneous interferometers with d_{x/y}=600/300 μm are shown in FIG. 8.

FIG. 7 shows the output signals of the nine simultaneous atom interferometers depending on T. The output signals of the nine atom interferometers which have been implemented with the BECs of the 2D arrangement are shown. The fit function

$${P}_{i} ( T ) = {a}_{i} + {b}_{i} \times cos ( {a}_{i , eff} {k}_{eff} {T}^{2} + d ) \times exp ( - Tf ) \qquad ( 1 )$$

allows the effectively acting acceleration to be determined. The offset aᵢ, contrast bᵢ, frequency a_{i,eff}, offset phase d and the decrease in the contrast fare fit parameters, while i indicates the i-th interferometer. a_{i,eff}, which can be determined for the interferometers 1-9 as 0.0747±0.0007, 0.0771±0.00064, 0.0771±0.0004, 0.0750±0.0006, 0.0775±0.0006, 0.0768±0.0004, 0.0752±0.0005, 0.0770±0.0005, 0.0765±0.0005 in m/s², is significant for inertial sensor technology. The correlation of the measurement data is shown in FIG. 8.

FIG. 8 shows a parametric view of the output signals of the nine simultaneous atom interferometers. Each interferometer signal is plotted against the middle interferometer (5) in order to map correlations.

FIG. 9 shows the output signals of the nine simultaneous atom interferometers in the 1D waveguide, or output signals of the nine atom interferometers if the atoms are held in the 1D waveguide.

### Phase Sensitivity and Discussion

Each BEC 5 of this arrangement can be made usable for interferometric measurements through double-Bragg diffraction. The exemplary embodiment shown in FIG. 2 thus provides a 3×3 matrix of interferometers I1, I2, I3, I4, I5, I6, I7, I8, I9. The correlated measurements thus obtained can be read out differentially in order to obtain information relating to acting i) accelerations, ii) gradients, iii) rotations and iv) rotational accelerations.

Sensitivity to accelerations in the x-direction along the Bragg beams is intrinsically contained in each of the nine interferometers. Inferences can be made regarding gradients which are scaled in each case with integral multiples of the distance dₓ through correlation of adjacent interferometers in the x-direction (rows). Rotational rates and accelerations can initially be described by a rotational movement of the retroreflex mirror of the Bragg beam positioned at the distance x_{M} from the atoms with coordinates x^{→}_{M}=(x_{M}, 0,0). The phase of the individual output signals of the interferometers is defined by:

$${ϕ}_{i} = 2 {k}_{eff} {T}^{2} [ {a}_{eff} + {v}_{yi} ( 2 ( {Ω}_{z} + {Ω}_{M} ) + {\dot{Ω}}_{M} T ) + 2 {v}_{zi} {Ω}_{y} + {y}_{i} ( {Ω}_{x} {Ω}_{y} ) + {\dot{Ω}}_{M} ) - {x}_{i} ( {Ω}_{y}^{2} + {Ω}_{z}^{2} ) + {z}_{i} {Ω}_{z} {Ω}_{z} + 2 ( {x}_{i} - {x}_{M} ) {Ω}_{M}^{2} ] \qquad ( 2 )$$

where Ω_{x/y/z} describes a rate of rotation around the corresponding axis, (x/y/z)ᵢ describes the position and v_{(x/y/z)}_{ᵢ} describes the velocities of the individual BECs before the application of the Bragg beams, x_{M} describes the distance between the retroreflex mirror and its center of rotation, and Ω_{M}, ′Ω_{M} describes the rate of rotation, or the rotational rate acceleration thereof. Differential phases between the individual interferometers are scaled with the distance between the BECs of the arrangement, and the distance d_{x/y} between the BECs of the arrangement must be maximized for the greatest possible differential phase Δϕᵢⱼ=ϕᵢ−ϕⱼ. The rate of rotation of the mirror can be adjusted and rotations can be simulated by implementing an amplified piezo actuator which can tilt the mirror. Similarly, a phase difference can thus be created and modified in steps in a controlled manner.

Due to the limited interferometry duration, Tis only a few ms long in the first proof-of-principle experiments. In order to demonstrate rotational measurements with the mirror, the rates of rotation or rotational rate acceleration must exceed Ω_{M}, ′Ω_{M}>0.1 rad/s or rad/s², which is possible with the piezo actuator. An increase in the evolution time can be achieved with guided interferometry, for which purpose the dipole trap beam is switched off in the y-direction. As a result, the atoms are no longer captured in the interferometry beam direction and can be held in the resulting 1D waveguide and can be manipulated with the interferometry beams. Initial interferometry results with the arrangement in the waveguide are shown in FIG. 7, but are not yet completely understood. The a_{eff} scale factors from the measurement shown in FIG. 7 become greater column-by-column: they are smallest for the interferometers 1, 4, 7 and increase successively column-by-column for the interferometers 2, 5, 8 and for 3, 6, 9. A tilting of the interferometry beams should result in equal scale factors a_{eff}. 3D simulations of the interferometer sequences will be carried out in collaboration with the Naceur Gaaloul group in order to understand the identified deviation.

The term of equation 2 dependent on V_{yi} can be measured by applying an initial velocity orthogonally to the interferometry beams. Semi-sigmoid frequency ramps which served as the input signal of the AOD in BP1 were measured by means of a 2×3 arrangement. The BEC arrangement was accelerated column-by-column by means of these ramps, and velocities of 70 mm/s could be identified for BEC 3, 6 (right column) and 35 mm/s for BEC 2, 5 (middle column) for a ramp with a maximum frequency deviation of 6 MHZ (right column) and a frequency deviation of 3 MHZ (middle column) and a ramp duration of 65 ms, while the left column was kept static.

### REFERENCES

[1] J. M. McGuirk et al. “Sensitive absolute-gravity gradiometry using atom interferometry”. In: Physical Review A 65.3 (February 2002). Publisher: American Physical Society (APS). DOI: 10.1103/physreva.65.033608.
[2] G. Rosi et al. “Measurement of the Gravity-Field Curvature by Atom Interferometry”. In: Physical Review Letters 114.1 (January 2015). Publisher: American Physical Society, p. 013001. DOI: 10.1103/PhysRevLett.114.013001. URL: https://link.aps.org/doi/10.1103/PhysRevLett.114.013001 (visited on Jan. 2, 2023).
[3] Romain Gautier et al. “Accurate measurement of the Sagnac effect for matter waves”. en. In: Science Advances 8.23 (Dune 2022), eabn8009. ISSN: 2375-2548. DOI: 10.1126/sciadv.abn8009. https://www.science.org/doi/10.1126/sciadv.abn8009 (visited on Jan. 2, 2023).
[4] P. Berg et al. “Composite-Light-Pulse Technique for High-Precision Atom Interferometry”. In: Phys. Rev. Lett. 114.6 (February 2015). Publisher: American Physical Society, p. 063002. DOI: 10.1103/PhysRevLett.114.063002.
[5] J. K. Stockton, K. Takase, and M. A. Kasevich. “Absolute Geodetic Rotation Measurement Using Atom Interferometry”. In: Physical Review Letters 107. 13 (September 2011). Publisher: American Physical Society, p. 133001. DOI: 10.1103/PhysRevLett. 107.133001. URL: https://link.aps.org/doi/10.1103/PhysRevLett.107.133001 (visited on Jan. 5, 2023).
[6] B. Barrett et al. “Multidimensional Atom Optics and Interferometry”. In: Phys. Rev. Lett. 122.4 (February 2019). Publisher: American Physical Society, p. 043604. DOI: 10. 1103/PhysRevLett. 122.043604. URL: https://link.aps.org/doi/10.1103/PhysRevLett.122.043604.
[7] Matthias Gersemann et al. “Differential interferometry using a Bose-Einstein condensate”. In: The European Physical Journal D 74.10 (2020), p. 203. ISSN: 1434-6079. DOI: 10.1140/epjd/e2020-10417-8. URL: https://doi.org/10.1140/epjd/e2020-10417-8.
[8] Susannah M. Dickerson et al. “Multiaxis Inertial Sensing with Long-Time Point Source Atom Interferometry”. In: Physical Review Letters 111.8 (August 2013). Publisher: American Physical Society, p. 083001. DOI: 10 1103/PhysRevLett 111. 083001. URL: https://link.aps.org/doi/10.1103/PhysRevLett.111.083001 (visited on Jan. 3, 2023).
[9] A. Wanner et al. “Seismic attenuation system for the AEI 10 meter Prototype”. en. In: Classical and Quantum Gravity 29.24 (November 2012). Publisher: IOP Publishing, p. 245007. ISSN: 0264-9381. DOI: 10.1088/0264-9381/29/24/245007. URL: https://dx doi.org/10.1088/0264-9381/29/24/245007 (visited on Jul. 5, 2023).
Nathan Shettel and Rainer Dumke. Emulating an Atomic Gyroscope with Multiple Accelerometers. arXiv: 2301.11155 [physics]. January 2023. DOI: 10.48550/arXiv.2301.11155. URL: http://arxiv.org/abs/2301.11155 (visited on Jan. 31, 2023).

1. A quantum inertial measurement unit for acquiring at least one physical measured quantity based on atom-interferometric acceleration measurement, comprising:
a) at least one atom trap configured to capture an atomic cloud,
b) at least one controllable splitting device configured to create a plurality of macroscopic atomic sub-clouds in a defined geometric arrangement, wherein the plurality of macroscopic atomic sub-clouds are spatially separated from one another, wherein the at least one splitting device is operable in combination with cold or ultracold quantum gases depending on at least one control signal in the atomic cloud captured in the atom trap,
c) at least one atomic optical light field device configured to carry out an atom-interferometric one-dimensional acceleration measurement based on the created plurality of macroscopic atomic sub-clouds, wherein an acceleration value is determined for each macroscopic atomic sub-cloud of the plurality of macroscopic atomic sub-clouds, and
d) at least one evaluation device configured to determine a physical measured quantity other than the measured one-dimensional acceleration values from the plurality of one-dimensional acceleration values obtained by the at least one atomic optical light field device.

2. The quantum inertial measurement unit according to claim 1, wherein the at least one controllable splitting device is configured to create the plurality of macroscopic atomic sub-clouds in a defined geometric arrangement in a form of a regular or irregular two-dimensional or three-dimensional matrix arrangement.

3. The quantum inertial measurement unit according to claim 2, wherein the matrix arrangement has at least two, at least four, at least six or at least nine matrix elements in each case in the form of the plurality of macroscopic atomic sub-clouds.

4. The quantum inertial measurement unit according to claim 2 wherein the defined geometric arrangement of the plurality of macroscopic atomic sub-clouds in one plane comprises an area of at least 0.5 mm².

5. The quantum inertial measurement unit according to claim 1 wherein the at least one evaluation device is configured to determine, as the physical measured quantity, at least one of
one or more rotational rates,
one or more rotational accelerations,
one or more acceleration gradients,
one or more magnetic field components, and/or
at least one other inertial measured quantity.

6. The quantum inertial measurement unit according to claim 1 further comprising at least one waveguide, wherein the at least one atom trap is configured to capture the atomic cloud in the at least one waveguide.

7. The quantum inertial measurement unit according to claim 1 wherein the at least one atomic optical light field device is configured to carry out interferometric measurements on the plurality of macroscopic atomic sub-clouds by a coherent single or multiple photon processes.

8. The quantum inertial measurement unit according to claim 1 wherein the at least one atom trap is designed as a magneto-optical atom trap.

9. The quantum inertial measurement unit according to claim 1 further comprising a cooling device to cool the atomic cloud, wherein the cooling device has an evaporative cooling arrangement.

10. The quantum inertial measurement unit according to claim 1 wherein the at least one controllable splitting device comprises at least one optical dipole trap and/or at least one magnetic trap.

11. The quantum inertial measurement unit according to claim 10, wherein the at least one optical dipole trap has at least two beam paths.

12. The quantum inertial measurement unit according to claim 1 wherein the at least one controllable splitting device comprises at least one controllable optical splitting unit for splitting at least one beam path of the optical dipole trap into a plurality of beam sub-paths.

13. A method for acquiring at least one physical measured quantity based on atom-interferometric acceleration measurement by a quantum inertial measurement unit as claimed in claim 1, comprising:
a) capturing an atomic cloud by an atom trap,
b) depending on at least one control signal, creating a plurality of macroscopic atomic sub-clouds in a defined geometric arrangement in the atomic cloud captured in the atom trap, wherein creating is accomplished using a controllable splitting device and cold or ultracold quantum gases,
c) measuring an atom-interferometric one-dimensional acceleration measurement by an atomic optical light field device and by the created macroscopic atomic sub-clouds, and determining an acceleration value for each macroscopic atomic sub-cloud, and
d) determining a physical measured quantity other than the measured one-dimensional acceleration values by at least one evaluation device, wherein determining is performed using the plurality of one-dimensional acceleration values obtained by the at least one atomic optical light field device.

14. The method according to claim 13, wherein the physical measured quantity is
one or more rotational rates,
one or more rotational accelerations,
one or more acceleration gradients,
one or more magnetic field components, and/or
at least one other inertial measured quantity.

15. The quantum inertial measurement unit of claim 11 wherein the at least two beam paths are parallel or intersecting.

16. The quantum inertial measurement unit of claim 12 wherein the at least one controllable splitting unit is a deflector.

17. The method of claim 13 wherein the cold or ultracold quantum gases are Bose-Einstein condensates.
